(19) United States
(12) Patent Application Publication
(10) Pub. No.: US 2011/0164420 A1
(43) Pub. Date: Jul. 7, 2011

(54) DIFFUSION STRUCTURE FOR ILLUMINATION LIGHT SOURCE

(76) Inventor: Hung-Wen LEE, Taipei City (TW)

(21) Appl. No.: 12/683,639

(22) Filed: Jan. 7, 2010

(51) Int. Cl. F21V 29/00; F21V 21/00; F21V 5/00

(52) U.S. Cl. 362/249.02; 362/373; 362/294

(57) ABSTRACT

The present invention relates to a diffusion structure for illumination light source, comprises: a substrate installed with at least one light emitting diode; a heat dissipating base, the periphery thereof is installed with at least one heat dissipating fin; a lamp head; a lower cover installed with at least one heat dissipating hole; and an upper cover, one end thereof is processed with an etching treatment by a chemical agent so the surface thereof is formed to an irregular concave-convex shape thus the lamp head is provided with more projection angles so as to increase the brightness. With the rough surface of the upper cover, lights emitted by the light emitting diode is able to be diffused, and the heat dissipating fin is disposed in the lower cover so that air can be introduced into the lower cover through the heat dissipating hole for generating convection so as to process heat dissipation to the heat dissipating fin, and users are prevented from being hurt by touching the heat dissipating fin.

### BACKGROUND OF THE INVENTION

1. Field of the Invention

The present invention relates to a diffusion structure for illumination light source, more particularly to a diffusion structure for illumination light source in which an upper cover is processed with an etching treatment by a chemical agent so the surface thereof is formed to an irregular concave-convex shape so a lamp head is provided with more projection angles for diffusing lights so as to increase the brightness and a lower cover is installed with at least one heat dissipating hole and a heat dissipating fin is installed in the lower cover for preventing users from touching the heat dissipating fin.

2. Description of Related Art

A light bulb using LEDs as light sources has high directivity, therefore is not suitable to be used as a general illumination having omnidirectionally projections, so lights emitted by the LEDs have to be processed with a diffusion treatment.

A conventional LED light bulb, for example the Taiwan Utility Patent No. M345944 has disclosed a LED light bulb, which is a commonly seen LED light bulb structure. Because the light source is disposed close to a hemisphere-like lamp housing, lights can only be straightly projected, the lower portion is shield by a metal heat dissipating base, therefore a purpose of lateral illumination of lamp base is not able to be achieved.

For improving illumination directions, the Taiwan Patent No. 1308200, the Taiwan Utility Patent No. M349157 and the Taiwan Utility Patent No. M354092 have all achieved the diffusion of light illuminating directions through altering the directivity of LED light sources, but a single light emitting diode has its height brightness so uniformity of omnidirectionally illumination is not likely to be achieved.

For diffusing LED light sources, the Taiwan Utility Patent No. M353290 has disclosed a diffusion member being installed on top of LEDs, so lights emitting by the LEDs can be guided by the diffusion member for achieving a purpose of light diffusion, so the light bulb is seen like an integrated illumination and the illumination range is increased.

But lights generated by the LED light bulbs disclosed in the mentioned patents can not be used like a conventional incandescent bulb or energy-saving bulb for providing omnidirectional illumination, and, when being installed on a wall, the mentioned LED light bulbs can not achieve illuminating the lamp base end or an area opposite to the LED illumination plane.

For improving the disadvantages of the mentioned conventional LED light bulbs, the present invention provides a diffusion structure for illumination light source.

### SUMMARY OF THE INVENTION

One primary object of the present invention is to provide a diffusion structure for illumination light source in which an upper cover is processed with an etching treatment by a chemical agent so the surface thereof is formed to an irregular concave-convex shape thus a lamp head is provided with more projection angles for diffusing lights so as to increase the brightness.

Another object of the present invention is to provide a diffusion structure for illumination light source in which a lower cover is installed with at least one heat dissipating hole and a heat dissipating fin is installed in the lower cover for allowing air to flow into the lower cover through the heat dissipating hole for generating convection so as to process heat dissipation to the heat dissipating fin, and user are prevented from touching the heat dissipating fin.

For achieving the above mentioned object, a diffusion structure for illumination light source is provided by the present invention, comprises: a substrate being installed with at least one light emitting diode; a heat dissipating base having a chamber for receiving the substrate, and the periphery thereof is installed with at least one heat dissipating fin; a lamp head disposed at one end of the heat dissipating base and coupled to the light emitting diode; a lower cover which is hollow for receiving the heat dissipating base and the lamp head is exposed out of one end of the lower cover, the other end of the lower cover is installed with an engagement base; and an upper cover which is hollow and one end thereof is installed with the engagement base for forming a sealed space.

### BRIEF DESCRIPTION OF THE DRAWINGS

FIG. 1 is a schematic exploded view of the diffusion structure for illumination light source of one preferred embodiment of the present invention;

FIG. 2 is an upper schematic view of the heat dissipating base of one preferred embodiment of the present invention;

FIG. 3 is a schematic view of the assembly of the diffusion structure for illumination light source of one preferred embodiment of the present invention.

### DETAILED DESCRIPTION OF THE PREFERRED EMBODIMENT

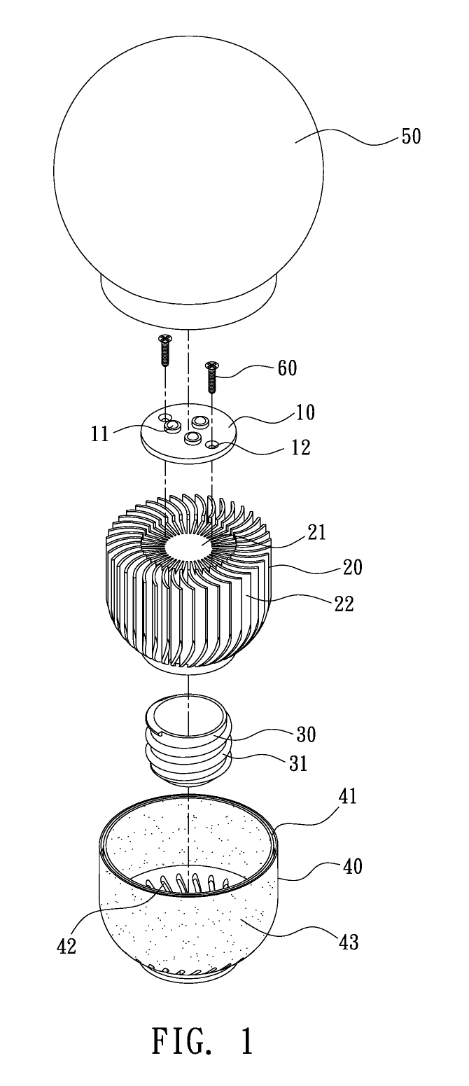

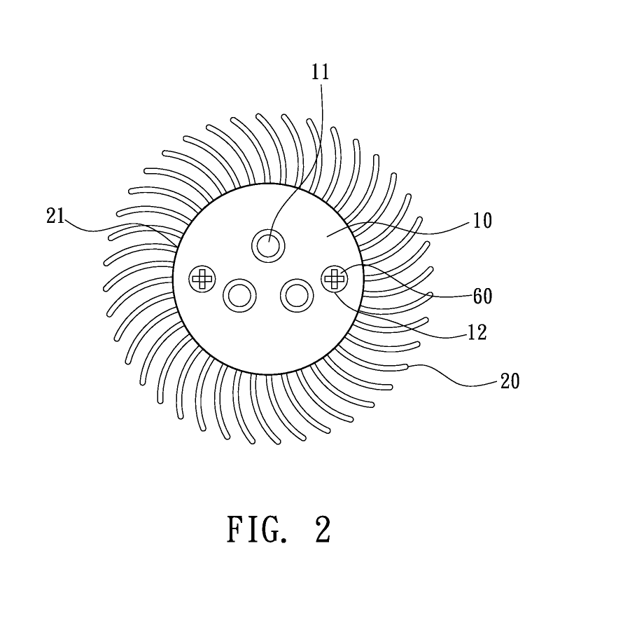

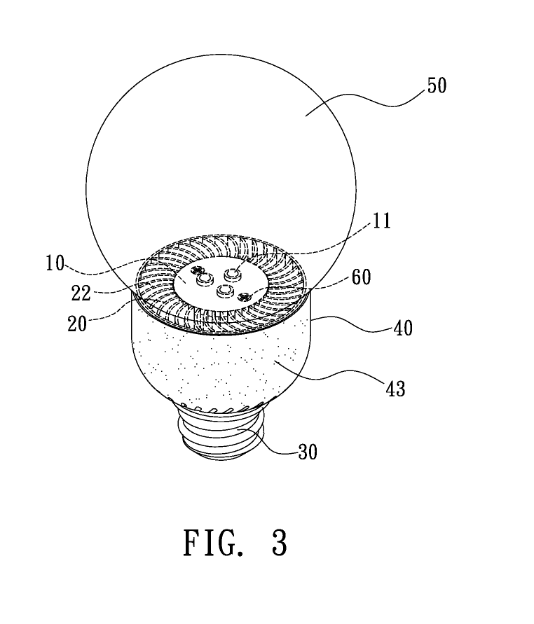

Referring from FIG. 1 to FIG. 3, wherein FIG. 1 is a schematic exploded view of the diffusion structure for illumination light source of one preferred embodiment of the present invention; FIG. 2 is an upper schematic view of the heat dissipating base of one preferred embodiment of the present invention; FIG. 3 is a schematic view of the assembly of the diffusion structure for illumination light source of one preferred embodiment of the present invention.

As shown in figures, the diffusion structure for illumination light source provided by the present invention comprises: a substrate 10; a heat dissipating base 20; a lamp head 30; a lower cover 40; and an upper cover 50.

The substrate 10 is, e.g. but not limited to, an aluminum substrate, and is installed with at least one light emitting diode 11; in this embodiment, three light emitting diodes 11 are adopted for illustration but not served as a limitation, wherein the light emitting diode 11, is, e.g. but not limited to, a DC or AC light emitting diode. The substrate 10 is installed with at least one fastening hole 12 so that at least one fastening member 60 is able to be installed in the fastening hole 12 for fixing the substrate 10 on the heat dissipating base 20, wherein the fastening member 60 is, e.g. but not limited to, a screw.

The heat dissipating base 20 is, e.g. but not limited to, a round column type heat dissipating base, and is provided with a chamber 21 for receiving the substrate 10, and the periphery thereof is installed with at least one heat dissipating fin 22 which is bended to a certain angle for increasing the heat dissipating area. The heat dissipating base 20 is made of high thermal conductive metal material, e.g. but not limited to copper or aluminum.

The lamp head 30 is installed at one end of the heat dissipating base 20, e.g. but not limited to a lower end, and is coupled to the light emitting diodes 11. The lamp head 30 is, e.g. but not limited to, an E26 or E27 lamp head, and an outer end thereof is further installed with thread 31 for being screw-fitted with a lamp base (not shown).

The lower cover 40 is made of, e.g. but not limited to, glass or plastic material, and is hollow for receiving the heat dissipating base 20, and the lamp head 30 is exposed out of one end of the lower cover 40, the other end of the lower cover 40 is installed with an engagement base 41. The lower cover 40 is further installed with at least one heat dissipating hole 42 for allowing air to flow into the lower cover 40 for generating convection so as to process heat dissipation to the heat dissipating fin 22. The lower cover 40, e.g. but not limited to the inner end, or the out end or both ends, is further coated with a static electricity layer 43 having a thickness of, e.g. but not limited to, 10 to 400 um for achieving a purpose of light refraction.

The upper cover 50 is, e.g. but not limited to, a G type, PS type, DP type, C type, S type, T type, ST type or R type lamp housing, and is made of, e.g. but not limited to, glass or plastic material; the upper cover 50 is hollow and one end thereof is installed with the engagement base 41 for forming a sealed space. And at least one end of the upper cover 50, e.g. but not limited to the inner end, the outer end or both ends, is processed with an etching treatment by a chemical agent, e.g. but not limited to hydrofluoric acid or hydrofluoric hydroammonia, so that the surface thereof is formed to an irregular concave-convex shape, thus the lamp head 30 is provided with more projection angles for diffusing lights emitted by the light emitting diodes 11, so as to increase the brightness.

As shown in FIG. 3, in assembly, firstly the substrate 10 is fastened on the heat dissipating base 20 through the fastening member 60, and the light emitting diodes 11 are connected to the lamp head 30 through conductive wires (not shown); then the heat dissipating base 20 is installed in the lower cover 40 and the lamp head 30 is exposed out of the lower cover 40; the upper cover 50 is installed with the engagement base 41 of the lower cover 40 and an adhesive member is used for fastening the two, so the assembly of the diffusion structure for illumination light source provided by the present invention is finished.

In operation, lights emitted by the light emitting diodes 11 are able to be omnidirectionally diffused through the concave-convex surface of the upper cover 50, and the static electricity layer 43 of the lower cover 40 is served to refract lateral lights, so the lateral light leakage is prevented and the intensity of straight light is enhanced. The heat dissipating fin 22 is disposed in the lower cover 40 and the upper cover 50 for preventing users from touching, the heat generated by the heat dissipating fin 22 is able to be sunk through air introduced from the heat dissipating hole 42. Therefore the diffusion structure for illumination light source provide by the present invention can improve disadvantages of conventional LED light bulbs.

As mentioned above, compared to a conventional diffusion structure for illumination light source, the diffusion structure for illumination light source provided by the present invention has following advantages: 1. the upper cover is processed with an etching treatment by a chemical agent so the surface thereof is formed to an irregular concave-convex shape and the lamp head is provided with more projection angles for diffusing lights, so as to increase the brightness; 2. at least one heat dissipating hole is installed on the lower cover and the heat dissipating fin is installed in the lower cover for preventing users from touching, the heat generated by the heat dissipating fin is able to be sunk through air introduced from the heat dissipating hole. Therefore the diffusion structure for illumination light source provide by the present invention is novel compared to conventional LED light bulbs.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A diffusion structure for illumination light source, comprising:
a substrate being installed with at least one light emitting diode;
a heat dissipating base having a chamber for receiving said substrate, and the periphery thereof being installed with at least one heat dissipating fin;
a lamp head disposed at one end of said heat dissipating base and coupled to said light emitting diode;
a lower cover, being hollow for receiving said heat dissipating base and said lamp head being exposed out of one end of said lower cover, the other end of said lower cover being installed with an engagement base; and
an upper cover, being hollow and one end thereof being installed with said engagement base for forming a sealed space.

2. The diffusion structure for illumination light source as claimed in claim 1, wherein said substrate is an aluminum substrate.

3. The diffusion structure for illumination light source as claimed in claim 1, wherein said light emitting diode is a DC or AC light emitting diode and the quantity installed is three.

4. The diffusion structure for illumination light source as claimed in claim 1, wherein said heat dissipating base is a round column type heat dissipating base, and said heat dissipating fin installed at the periphery thereof is bended to a certain angle for increasing the heat dissipating area.

5. The diffusion structure for illumination light source as claimed in claim 1, wherein said heat dissipating base is made of high thermal conductive metal material.

6. The diffusion structure for illumination light source as claimed in claim 5, wherein said high thermal conductive material is copper or aluminum.

7. The diffusion structure for illumination light source as claimed in claim 1, wherein said lamp head is an E26 or E27 lamp head.

8. The diffusion structure for illumination light source as claimed in claim 1, wherein said lower cover is further installed with at least one heat dissipating hole for allowing air to flow into said lower cover for generating convection so as to process heat dissipation to said heat dissipating fin.

9. The diffusion structure for illumination light source as claimed in claim 1, wherein said lower cover and said upper cover are made of glass or plastic material.

10. The diffusion structure for illumination light source as claimed in claim 1, wherein at least one end of said upper cover is processed with an etching treatment by a chemical agent so the surface thereof is formed to an irregular concave-convex shape thus said lamp head is provided with more projection angles for diffusing lights so as to increase the brightness.

11. The diffusion structure for illumination light source as claimed in claim 10, wherein said chemical agent is hydrofluoric acid or hydrofluoric hydroammonia.

12. The diffusion structure for illumination light source as claimed in claim 10, wherein at least one end of said lower cover is further coated with a static electricity layer for refracting lights.

13. The diffusion structure for illumination light source as claimed in claim 12, wherein the thickness of said static electricity layer is about 10-400 um.

14. The diffusion structure for illumination light source as claimed in claim 12, wherein said upper cover is a G type, PS type, DP type, C type, S type, T type, ST type or R type lamp housing.

15. The diffusion structure for illumination light source as claimed in claim 1, wherein said substrate is further installed with at least one fastening hole.

16. The diffusion structure for illumination light source as claimed in claim 15, wherein further being installed with at least one fastening member installed in said fastening hole for fixing said substrate on said heat dissipating base.
